(19) United States
(12) Patent Application Publication
(10) Pub. No.: US 2007/0297493 A1
(43) Pub. Date: Dec. 27, 2007

(54) Efficient Maximal Ratio Combiner for Cdma Systems

(76) Inventors: Alton Shelborne Keel, Melbourne, FL (US); Louis Robert Litwin, Plainsboro, NJ (US); Wen Gao, West Windsor, NJ (US)

Correspondence Address: THOMSON LICENSING LLC, Two Independence Way, Suite 200, PRINCETON, NJ, 08540, US

(21) Appl. No.: 11/795,049

(22) PCT Filed: Jan. 14, 2005
(86) PCT No.: PCT/US05/00762

§ 371 Date: Jul. 10, 2007

(51) Int. Cl. H04B 1/707; H04B 1/00

(52) U.S. Cl. 375/147; 375/E01.002

(57) ABSTRACT

A receiver comprises a number of fingers, each finger providing symbols associated with a path of a received multipath signal, and a maximal ratio combiner (MRC) that activates to combine the symbols when the symbols are available. In an illustrative embodiment a receiver is a CDMA receiver and comprises a number of fingers, an interface, and an MRC. Each finger provides symbols asociated with a path of a received multipath signal for the various channels conveyed therein, the interface provides an indiction when symbols from the fingers are ready for processing to the MRC, which then activates to combine those symbols from the fingers that are asociated with the same channel. Illustratively, the interface includes a priority encoder for selecting different channels for processing by the MRC. Further, the MRC can be configured to operate with a clock rate that is greater than a chip rate. By selectively activating the MRC, or at least a portion thereof, a reduction in the number of combining circuits can be achieved within the MRC.

### BACKGROUND OF THE INVENTION

The present invention relates to a receiver architecture for use with Code Division Multiple Access (CDMA) and spread spectrum wireless networks.

CDMA is a variety of spread spectrum technology that refers to any of several protocols used in so-called second-generation (2G) and third-generation (3G) wireless communications. CDMA is a form of multiplexing that allows numerous signals (channels) to occupy a single physical transmission channel, thereby optimizing bandwidth. These signals are transmitted using the same frequency band and are differentiated by transmitting each signal using a different spreading code.

In practice, multiple delayed versions of a transmitted CDMA signal arrive at a CDMA receiver. For example, one version of the signal may arrive by traveling a direct path from a base station to the CDMA receiver, while another version may arrive later because the signal reflected off of a building before its arrival. As such, the received signal is also known as a multipath signal and contains multiple delayed versions of the transmitted signal. Each version of the transmitted signal is known as a path.

During decoding, the CDMA receiver processes a received multipath signal to identify the various paths contained therein. This function, performed by a searcher, traditionally is implemented by correlating received samples against different offsets of a scrambling code. A correlator, or a processor that performs correlation, can demodulate a spread spectrum signal and/or measure the similarity of an incoming signal against a reference. In any case, the searcher generates a signal profile, which is a vector of the correlation output at different time delays.

This signal profile is examined to determine the delays of the multipath signal at which various paths are identified. The information obtained from the signal profile is used to drop individual fingers of a rake receiver portion of the CDMA receiver onto the identified paths of the multipath signal. The fingers typically are implemented as baseband correlators. Each finger provides symbol output for a particular path for the various channels conveyed therein (via the above-mentioned spreading codes). Those symbols from the various fingers that represent different paths of the same channel are derotated and combined using a maximal ratio combiner (MRC) to form an estimate of the received symbol for that channel. This combination of the various paths may result in improving the received signal-to-noise ratio (SNR) for that channel.

Different channels, however, have different spreading factors (SF). Within CDMA systems, the SF refers to the number of chips needed per data symbol. The lower the spreading factor, the higher the data rate. For example, one channel may have a spreading factor of 256 whereas another may have a spreading factor of 4. In consequence, different numbers of channels must be combined during different clock cycles within the MRC.

A conventional MRC runs combiner logic at the least common multiple of the SF for the various channels to be combined. For instance, if a system has spreading factors that range from 4 to 512, the combiner logic would be run every 4 chips. Each time the combiner logic runs, the MRC checks each channel to determine whether symbols from identified paths for that channel should be derotated and combined. During some chips, no processing will be needed. During other chips, however, symbols from two or more, or all, of the channels will need to be derotated and combined.

Because of the varying number of channels to be processes, a large amount of parallel configured hardware is required to implement combining logic. Such a design can be costly in terms of gate count and power consumption. It would be advantageous to provide a hardware-efficient MRC for use with a CDMA receiver that overcomes the deficiencies described above.

### SUMMARY OF THE INVENTION

In accordance with the principles of the invention, a receiver comprises a number of fingers, each finger providing symbols associated with a path of a received multipath signal, and a maximal ratio combiner (MRC) that activates to combine the symbols when the symbols are available.

In an illustrative embodiment a receiver is a CDMA receiver and comprises a number of fingers, an interface, and an MRC. Each finger provides symbols associated with a path of a received multipath signal for the various channels conveyed therein, the interface provides an indication when symbols from the fingers are ready for processing to the MRC, which then activates to combine those symbols from the fingers that are associated with the same channel. Illustratively, the interface includes a priority encoder for selecting different channels for processing by the MRC. Further, the MRC can be configured to operate with a clock rate that is greater than a chip rate.

In another illustrative embodiment, a receiver processes different paths of a received multipath signal when data from the different paths are available. In particular, the receiver detects data is available for processing from the different paths of the received multipath signal and, upon detection, combines the data from the different paths of the received multipath signal.

In another illustrative embodiment, combination logic for combining signals from different paths of a received multipath signal is selectively activated upon detection that the signals from the different paths are ready for processing. If no signals from the different paths are ready for processing, the combination logic is deactivated.

### BRIEF DESCRIPTION OF THE DRAWINGS

Preferred embodiments of the present invention will be described below in more detail, with reference to the accompanying drawings, in which:

FIG. 1 is a schematic diagram illustrating one embodiment of a receiver in accordance with the inventive arrangements disclosed herein;

FIG. 2 is a schematic diagram illustrating one embodiment of a maximal ratio combiner (MRC) that can be used with the receiver of FIG. 1; and

FIGS. 3 and 4 are flow charts illustrating a method of operation relating to the MRC of FIG. 2 in accordance with one embodiment of the present invention.

### DETAILED DESCRIPTION

Other than the inventive concept, the elements shown in the figures are well known and will not be described in detail. Also, familiarity with UMTS-based wireless communications systems is assumed and is not described in detail herein. For example, other than the inventive concept, spread spectrum transmission and reception, cells (base stations), user equipment (UE), downlink channels, uplink channels, the searcher, combiner and RAKE receivers are well known and not described herein. In addition, the inventive concept may be implemented using conventional programming techniques, which, as such, will not be described herein. Finally, like-numbers on the figures represent similar elements.

In accordance with the inventive arrangements disclosed herein, a maximal ratio combiner (MRC), or at least a portion thereof, is selectively activated for derotating and combining symbols from a number of paths of a received multipath signal. By selectively activating the MRC, or at least a portion thereof, a reduction in the number of combining circuits can be achieved within the MRC.

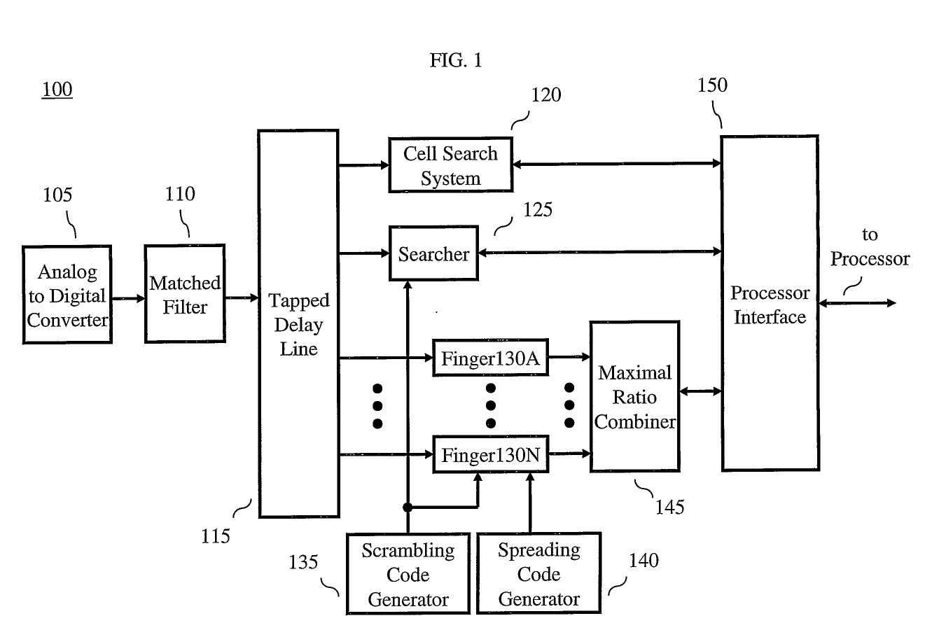

FIG. 1 is a schematic diagram illustrating a receiver 100 in accordance with the inventive arrangements disclosed herein. In one embodiment, the receiver is a CDMA receiver. As shown in FIG. 1, the receiver 100 comprises an analog-to-digital converter 105 for converting received analog signals into digital representations thereof. The resulting digital signals are provided to a matched filter 110.

Filtered signals are provided to a tapped delay line 115. The latter receives samples of a received multipath signal and provides different delayed versions therof. Outputs of the tapped delay line 115, called taps, feed samples to the cell search 120, the searcher 125, and each of the fingers 130A-130N. The tapped delay line 115 can be sub-chip in terms of resolution. Each tap can provide samples as output for a particular one of the different delayed versions of the received multipath signal.

The signal provided to the cell search system 120 includes timing information. More particularly, the signal includes a composite Synchronization Channel (SCH) and a Common Pilot Channel (CPICH). The cell search system 120 determines timing information using the provided signal and performs operations such as slot synchronization, frame synchronization, and scrambling code determination.

A scrambling code generator 135 provides the determined scrambling codes needed by the searcher 125 and the fingers 130A-130N. In one embodiment, scrambling code generator 135 generates the scrambling codes dynamically. For example, and as known in the art, a scrambling code generator utilizes hardware-implemented linear feedback shift registers (LFSRs) to generate scrambling codes, one LFSR per scrambling code. An LFSR generates a scrambling code dynamically, or “on the fly”, with a new scrambling code chip value being generated for each chip. (A scrambling code covers a UMTS frame (38,400 chips) and comprises 38,400 chip values.) In another embodiment, the scrambling code generator 135 is a memory in which the scrambling code determined by the cell search system 120 is stored. Thus, the scrambling code generator 135 can be implemented as a memory or a memory block, such as a memory with accompanying logic for storing the 38,400 chip values of the scrambling code. (It should be noted that each scrambling code chip value may further comprise in-phase (I) and quadrature (Q) components.)

The searcher 125, using a scrambling code obtained from the scrambling code generator 135, correlates the received multipath signal to obtain profiles of, and identify, the locations of the various paths within the received multipath signal.

Each of the fingers 130A-130N is assigned to extract a different path of the received multipath signal as determined by the searcher 125. Fingers 130A-130N process the various paths using a spreading code provided by a spreading code generator 140. Each finger provides pilot data for the pilot channels conveyed in the processed path, along with symbol data and symbol marks for the data channels conveyed in the processed path. It should be noted that as a result of the use of the tapped delay line 115, the outputs of the fingers 130A-130N will be time-aligned.

Appreciably, should other more conventional mechanisms for providing signal to the fingers 130A-130N be used, a delay mechanism can be incorporated at the output of each respective finger 130A-130N to ensure that the finger outputs are time aligned with one another prior to being provided to the MRC 145. Regardless, and in accordance with the principles of the invention (described further below), MRC 145 derotates symbols from the paths of the multipath signal received from each finger 130A-130N using the CPICH signal. The MRC 145 produces a constructively combined signal that is provided to the processor interface 150.

A processor (not shown) can be included to facilitate communications among the various components of the receiver 100 through the processor interface 150. Thus, e.g., the various fingers 130A through 130N can be assigned to different paths of the received multipath signal as determined by searcher 125.

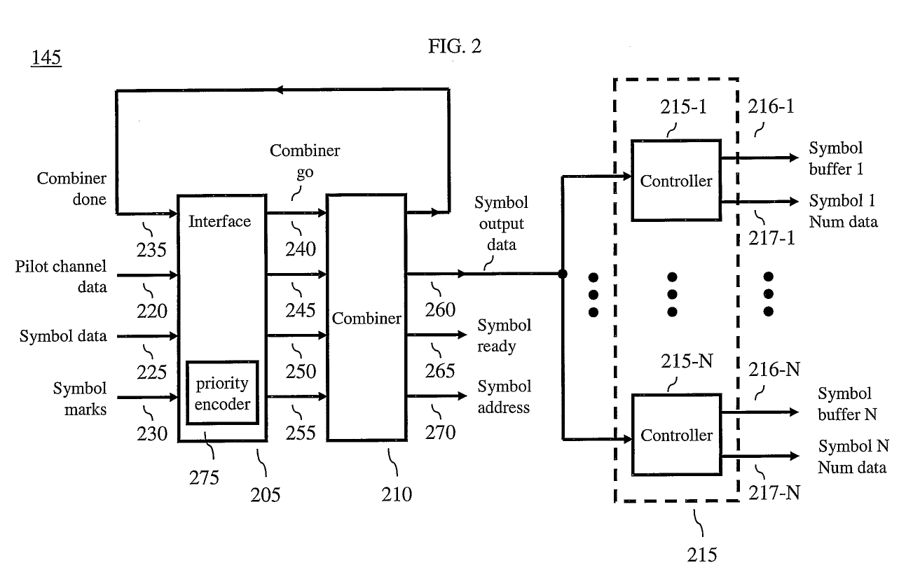

FIG. 2 is a schematic diagram showing an illustrative embodiment of MRC 145 that can be used with the CDMA receiver of FIG. 1. The MRC 145 can be implemented as one or more integrated circuits and/or discrete components. For example, the MRC 145 can include controllers, microprocessors, digital signal processors (DSPs), application specific integrated circuits (ASICs), and/or field programmable gate arrays (FPGAs). As shown, the MRC 145 comprises: an interface 205, a combiner 210, and a plurality of controllers 215, the plurality of controllers 215 comprising N controllers, 215-1 through 215-N.

The interface 205 receives data from a plurality of different fingers of a rake receiver in the CDMA receiver (e.g., finger130A, etc., of FIG. 1). In one embodiment, the CDMA receiver includes 6 fingers. The invention, however, is not intended to be limited by the number of fingers used. In any case, data for 12 channels can be received from the 6 fingers. In the UMTS 3G standard, the maximum number of possible simultaneous channels is 12. Accordingly, interface 205 receives pilot channel data 220 for 12 pilot channels, symbol data 225 for 12 data channels, and symbol marks 230 for 12 data channels from the fingers.

The symbol marks 230 are indicators of when symbols are available to the MRC 145. In other words, a symbol mark indicates to the MRC 145 when a valid symbol has been received. A symbol mark for a given channel is valid after the rake receiver has computed the correlation output associated with that symbol. In illustration, if the spreading factor (SF) of a channel was 256 chips, the symbol mark for that channel would indicate that a valid symbol was present every 256 chips. Typically, the symbol mark is a single bit corresponding to a particular channel. The bit can be set high or low to indicate the presence, or lack thereof, of a valid symbol on the channel.

The interface 205 further comprises a priority encoder 275. The priority encoder 275 is configured to analyze the symbol marks for the various channels. From this analysis, the priority encoder 275 determines which, if any, of the symbol data 225 for the various channels should be forwarded on to the combiner 210 for processing. In particular, the priority encoder 275 calculates symbol ready flags (not shown) for each channel that indicate when symbols are present on a given channel. A symbol ready flag for a channel is determined as the “OR” of all 6 symbol marks for a channel from each of the six fingers.

Thus, 12 symbol ready flags can be evaluated, one for each channel. It should be noted that although the inventive concept is described in the context of six fingers, the inventive concept is not so limited and applies to any number of fingers.

The interface 205 is notified when the combiner 210 has finished processing and is ready to receive additional data. The combiner done signal 235, provided from the combiner 210, provides this notification. When the combiner done signal 235 is “true,” the interface 205 examines the symbol ready flags for each of the 12 channels. If any of the symbol ready 25 flags indicates that data is present for processing, the interface 205 provides a “true” combiner go signal 240 to the combiner 210. The interface 205 provides the combiner 210 with data for 6 paths at a time. As shown, the combiner 210 receives pilot channel data 245 for 6 paths and symbol data 250 for 6 paths.

In particular, the interface 205 selectively sends valid symbols to the combiner 210 as needed. For example, if a symbol ready flag corresponding to channel 1 indicates that a valid symbol is present, then the interface 205 sends the combiner 210 the symbol for channel 1. If the symbol ready flag for channel 2 indicates that a symbol is present on channel 2, the interface 205 sends the combiner 210 the symbol for channel 2, and so on. Output from the interface 205 to the combiner 210 can be sent from a priority multiplexer (not shown) disposed within the interface 205.

In accordance with the principles of the invention, the combiner 210 derotates and combines symbols from incoming channels after detecting a “true” combiner go signal 240. The combiner 210 includes a state machine for monitoring the combiner go signal 240. Accordingly, the combiner 210 can be inactive when the combiner go signal 240 is “false” and become active when the combiner go signal 240 is “true.” Thus, when the combiner go signal 240 is “true,” the combiner 210 is activated. At that point, the combiner done signal 235 is set to “false.” The combiner 210 derotates and combines any received symbol data 250. A symbol mark pending signal 255, provided from the interface 205 to the combiner 210, indicates which channels have valid symbol data 250 and are in need of derotating and combining. When the combiner 210 is finished processing, the combiner done signal 235 is changed to “true,” thereby indicating to the interface 205 that the combiner 210 can process further data.

Symbol output data 260 is provided from the combiner 210 to the plurality of controllers 215. A symbol ready signal 265 is provided from the combiner 210 and indicates that output is ready. The combiner 210 also provides an address signal 270 that indicates which one, or ones, of the controllers 215-1 through 215-N is to process the symbol output signal 260. The symbol ready signal 265 and the symbol address signal 270 are provided to controlling logic (not shown). The controlling logic determines which one, or ones, of the controllers 215-1 through 215-N is to receive the symbol as determined by the symbol address. Accordingly, particular ones of the controllers 215-1 through 215-N, as indicated by the symbol address signal 270, can process the received symbol(s) and provide a symbol buffer output and symbol number data output as shown.

As noted, the particular controller(s) 215-1 through 215-N which is to receive an output symbol is determined by the symbol address 270 as interpreted by the controller logic. The controllers 215-1 through 215-N serve to buffer the symbols until the processor is available to read the data (available via signals 216-1 through 216-N). The controllers 215-1 through 215-N further notify the processor as to the number of symbols in the buffer (available via signals 217-1 through 217-N). With this information, the processor essentially knows how many symbols to read from the buffer.

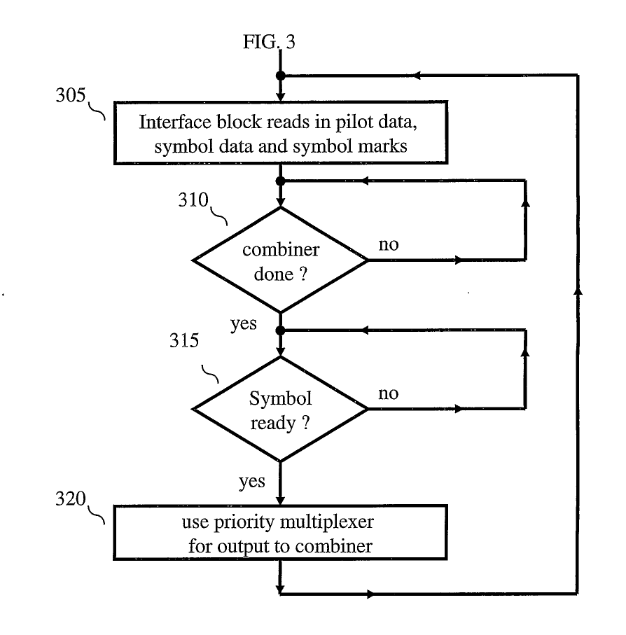

FIG. 3 is a flow chart illustrating a method of operation relating to the MRC of FIG. 2 in accordance with one embodiment of the present invention. More particularly, the flow chart of FIG. 3 illustrates one embodiment of a method of operation for the interface portion of the MRC, e.g., interface 205. The method can begin in step 305, where the interface reads in pilot data, symbol data, and symbol marks. In accordance with one embodiment, for example where 6 fingers are included in the spread spectrum receiver, 72 pilots, data symbols, and symbol marks can be read. The number 72 results from reading 12 channels from each of the six fingers. Still, it should be appreciated that the present invention is not limited by the amount of information read as the amount can vary with the hardware architecture of the spread spectrum receiver.

In step 310, the interface evaluates the combiner done signal, waiting for the combiner done signal to be “true.” When the combiner done signal becomes “true,” then interface 205 waits for a symbol ready flag in step 315. As noted, a symbol ready flag for a channel is determined as the “OR” of all 6 symbol marks together for that channel. Thus, 12 symbol ready flags can be evaluated, one for each channel. Also, in step 315, the combiner go signal is determined as the “OR” of all 12 of the symbol ready flags. As such, once a symbol ready flag for a channel is “true,” the combiner go signal is set to “true” and execution proceeds to step 320.

In step 320, output is selectively provided to the combiner. As noted, the interface includes a priority multiplexer to provide output to the combiner. If more than one symbol ready flag is true, the higher priority channel is selected. Thus, e.g., if the symbol ready flag pertaining to channel 1 is “true” and the symbol ready flag for channel 2 is also “true”, and channel 1 has a higher priority, then the pilot and symbol for channel 1 are first routed to the output and sent to the combiner. Then, the pilot and symbol for channel 2 are routed to the output and sent to the combiner. The method can repeat as may be required.

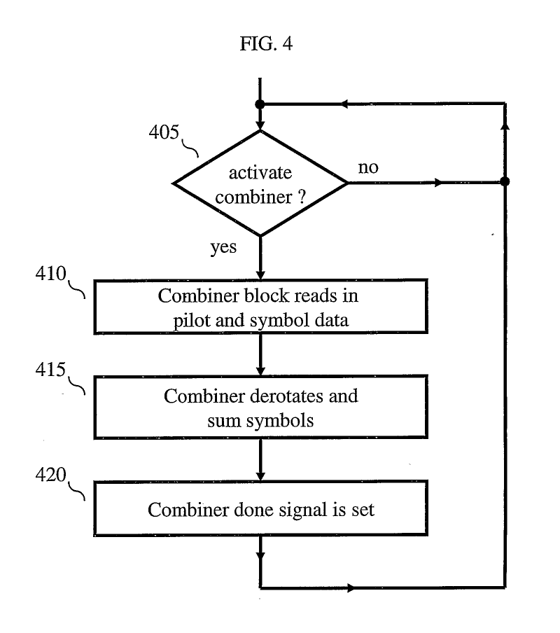

FIG. 4 is a flow chart illustrating a method of operation relating to the MRC of FIG. 2 in accordance with another embodiment of the present invention. The method of FIG. 4 illustrates one embodiment for a method of operation for the combiner of the MRC. In step 405, the MRC is activated when the combiner go signal is “true.” If not, the MRC remains deactivated until such time as the combiner go signal becomes “true.” When the combiner go signal becomes “true,” the method continues to step 410.

In step 410, the combiner reads in pilot and symbol data. As noted, in one embodiment, 6 pilot symbols and 6 data symbols can be read for a particular channel. In step 415, the symbols are derotated and summed for the particular channel. The symbols can be derotated by multiplying each symbol by the complex conjugate of its corresponding pilot symbol. After derotation, the data symbols for the particular channel are summed. Also in step 415, the combiner, having knowledge of the particular channel of the 12 “physical channels” to which the symbol belonged, routes the result to the appropriate controller. In step 420, the combiner done signal is set to “true” and the combiner is deactivated, returning to step 405.

The foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs) and/or in one or more stored program-controlled processors (e.g., a microprocessor or digital signal processor (DSP)). Similarly, although illustrated in the context of a UMTS-based system, the inventive concept is applicable to other communications system. It is therefore to be understood that numerous modifications may be made to the illustrative embodiments and that other arrangements may be devised without departing from the spirit and scope of the present invention as defined by the appended claims.

1. A receiver comprising:
a number of fingers, each finger providing symbols associated with a path of a received multipath signal; and
a maximal ratio combiner (MRC) that activates to combine the symbols when the symbols are available.

2. The receiver of claim 1, wherein the MRC comprises:
an interface configured to receive the symbols from the number of fingers and for providing an indication when symbols from at least one of the fingers is ready for processing; and
a combiner that is selectively activated based upon the indication from said interface, wherein said combiner processes particular ones of the symbols only when activated.

3. The receiver of claim 2, wherein the interface receives symbol marks indicating when symbols from the fingers are ready for processing, said interface comprising a priority encoder for evaluating the symbol marks.

4. The receiver of claim 3, wherein the priority encoder selects symbols associated with individual ones of a plurality of channels to send to the combiner according to an evaluation of the symbol marks.

5. The receiver of claim 4, wherein said priority encoder evaluates the symbol marks by performing a logical “OR” operation of all symbol marks for a given channel and forwards symbol data for channels having a true result from the “OR” operation.

6. The receiver of claim 1, wherein the MRC has a clock rate that is greater than a chip rate.

7. The receiver of claim 1, wherein the receiver is a Code Division Multiple Access (CDMA) receiver.

8. A method for use in a receiver, the method comprising:
providing an indication when data is available for at least one of a plurality of channels of a multipath signal; and
derotating and combining the data from individual ones of a plurality of paths of the multipath signal for at least one of the plurality of channels responsive to said indication.

9. The method of claim 8, wherein the derotating and combining step includes the step of selectively activating combination logic for performing said derotating and combining of the data.

10. The method of claim 9, further comprising the step of determining which of the plurality of channels to process based upon a symbol mark pending signal.

11. The method of claim 9, further comprising the steps of:
indicating that no data from the plurality of channels is available; and
deactivating combination logic.

12. The method of claim 8, wherein the step of derotating and combining continues to derotate and combine the data until receiving an indication that no data from individual ones of the plurality of channels is to be processed.

13. The method of claim 8, wherein the spread spectrum receiver is a Code Division Multiple Access (CDMA) receiver.
